(19) United States
(12) Patent Application Publication
(10) Pub. No.: US 2012/0081413 A1
(43) Pub. Date: Apr. 5, 2012

(54) DISPLAY APPARATUS AND METHOD FOR DRIVING DISPLAY APPARATUS

(75) Inventors: Masaki Nose, Kawasaki (JP); Hirokata Uehara, Kawasaki (JP)

(73) Assignee: FUJITSU LIMITED, Kawasaki (JP)

(21) Appl. No.: 13/233,288

(22) Filed: Sep. 15, 2011

(30) Foreign Application Priority Data
Sep. 30, 2010 (JP) 2010-222929

(51) Int. Cl. G09G 5/10; G09G 3/36; G09G 5/00

(52) U.S. Cl. 345/690; 345/212; 345/88

(57) ABSTRACT

A display apparatus comprising: a display device comprising a cholesteric liquid crystal layer and electrodes sandwiching the cholesteric liquid crystal layer and applying a voltage to a pixel; a voltage driver capable of applying a first pulse and a second pulse to the electrodes, the first and second pulses having different polarities; and a directing circuit directing the voltage driver as to a position to which the first pulse is to be applied and a position to which the second pulse is to be applied in a predetermined period according to a gray level to be produced in the pixel.

### CROSS REFERENCE TO RELATED APPLICATION

This application is based upon and claims the benefit of priority from the prior Japanese Patent Application NO. 2010-222929 filed on Sep. 30, 2010, the entire contents of which are incorporated herein by reference.

### FIELD

The embodiments discussed herein are related to a display apparatus using a cholesteric liquid crystal and a method for driving the display apparatus.

### BACKGROUND

Display apparatuses using cholesteric liquid crystals are expected to find uses as displays such as electronic paper, sub-displays of mobile terminals, and displays on IC cards.

The dominating drive scheme for driving a cholesteric liquid crystal display is a simple matrix scheme. A typical simple matrix scheme, a dynamic drive scheme (DDS) has been proposed for achieving a high speed and high contrast.

In the DDS, a driving signal that drives a cholesteric liquid crystal display includes a series of a “preparation stage”, a “selection stage” and an “evolution stage”. For convenience of description, these stages will be referred to as a “preparation pulse”, a “selection pulse” and an “evolution pulse”, respectively, herein. A non-selection pulse that does not relates to refresh is applied before and after the series of the preparation pulse, the selection pulse and the evolution pulse. The preparation pulse is a pulse that initializes the cholesteric liquid crystal to a homeotropic state. The selection pulse is a pulse that triggers transition of the cholesteric liquid crystal to a focal state or a planar state, in either of which the cholesteric liquid crystal will be ultimately placed. When the cholesteric liquid crystal is to be ultimately placed in the planar state, the selection pulse maintains the cholesteric liquid crystal in the homeotropic state; when the cholesteric liquid crystal is to be ultimately paced in the focal conic state, the selection pulse causes transition of the cholesteric liquid crystal to a transient planar state. The evolution pulse settles the cholesteric liquid crystal placed in the transient state by the preceding selection pulse into the planar or focal conic state.

The period during which the selection pulse is being applied to one line is approximately in the range of 0.5 ms to 1 ms. Scan refresh on an XGA (1024×768 pixels) screen takes only 1 second. Thus, the DDS may quickly refresh a cholesteric liquid crystal display.

On the other hand, gray levels of pixels of the cholesteric liquid crystal display are set by changing the pulse voltage of the selection pulse.

Here, since seven voltage levels or so are used for producing the preparation and evolution pulses, a circuit that controls the cholesteric liquid crystal display includes multiple voltage drivers that drive those voltage levels.

Since a number of voltage levels are used to change the pulse voltage of the selection pulse in addition to these voltage levels, multiple additional voltage drivers are used in the control circuit.

Accordingly, producing a multi-level gray scale with the DDS has entailed an increase in power consumption, which has prevented production of a high-precision gray scale.
[Patent document] U.S. Pat. No. 5,748,277

### SUMMARY

According to one aspect of an embodiment, there is provided a display apparatus including: a display device including a pixel and an electrode connected to the pixel; a voltage driver capable of applying a set of pulses including first and second pulses having different polarities to the electrodes; and a directing circuit selecting one of the two or more pulse types, a pulse duty for the first pulse and a pulse duty for the second pulse according to a gray level of the pixel and indicating the result of the selection to the voltage driver. The number of gray levels that the pixel may display is set by a combination of the two or more pulse types, the pulse duty of the first pulse, and the pulse duty of the second pulse.

The object and advantages of the embodiments will be realized and attained by means of the elements and combinations particularly pointed out in the claims.

It is to be understood that both the foregoing general description and the following detailed description are exemplary and explanatory and are not restrictive of the embodiments, as claimed.

### BRIEF DESCRIPTION OF DRAWINGS

FIG. 1 is a block diagram illustrating a display apparatus 30 according to an embodiment;

FIG. 2 is a diagram illustrating a cross-sectional structure of a cholesteric liquid crystal display device 10 included in the display apparatus of the present embodiment;

FIG. 3 is a diagram illustrating a cross-sectional structure of another cholesteric liquid crystal display device 20;

FIGS. 4A and 4B are diagrams illustrating bistability of a cholesteric liquid crystal;

FIG. 5 illustrates an example of voltage versus response characteristics of a typical cholesteric liquid crystal;

FIG. 6 is a diagram illustrating dynamic driving of a cholesteric liquid crystal in the present embodiment;

FIG. 7 illustrates pulse waveforms that may be used as a pair of selection pulses illustrated in FIG. 6;

FIG. 8 illustrates power supply drivers requested for providing preparation, selection and evolution pulses;

FIG. 9 illustrates combinations of voltage drivers for generating voltages used for preparation, selection, and evolution pulses;

FIG. 10 is a diagram illustrating exemplary states of preparation pulse, selection and evolution pulses where the selection pulse is of a Center type;

FIG. 11 is a diagram illustrating exemplary states of preparation pulse, selection and evolution pulses where the selection pulse is of a Far type;

FIG. 12 is a diagram illustrating exemplary states of preparation pulse, selection and evolution pulses where the selection pulse is of a Head type;

FIG. 13 is a diagram illustrating exemplary states of preparation pulse, selection and evolution pulses where the selection pulse is of a Tail type;

FIG. 14 is a graph of pulse duties and brightness of the Center-type, Far-type, Head-type and Tail-type selection pulses;

FIG. 15 illustrates an example in which pulse-width modulated selection pulses of different types are used in combination to produce eight gray levels;

FIG. 16 illustrates an example in which pulse-width modulated selection pulses of different types are used in combination to produce a 16 gray levels; and

FIG. 17 is a flowchart illustrating a method for refreshing a screen performed in the display apparatus 30 in FIG. 1.

### DESCRIPTION OF EMBODIMENTS

The present invention also encompasses embodiments described below to which any design modifications that may occur to those skilled in the art are made or in which any components appearing in the embodiments are replaced. The present invention also encompasses embodiments in which any of the components is replaced with another component that has the same effects as the component and is not limited to the embodiments described below.

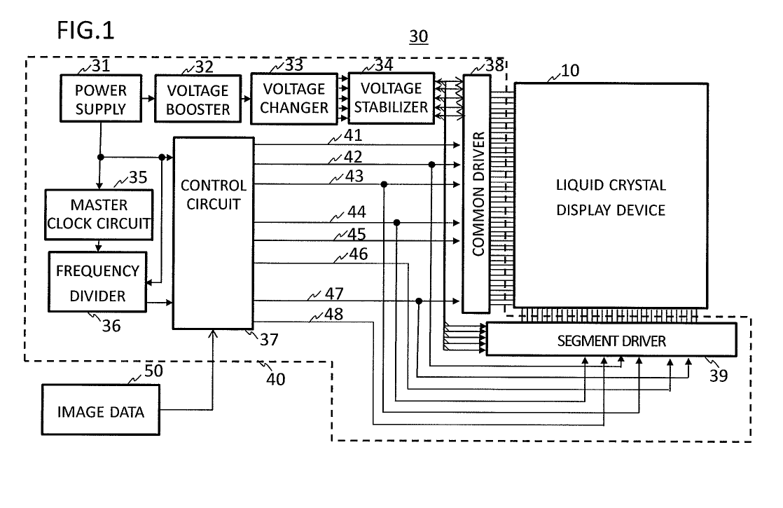

FIG. 1 is a block diagram illustrating a display apparatus 30 of an embodiment. The display apparatus 30 of the embodiment includes a driving circuit 40 and a liquid crystal display device 10.

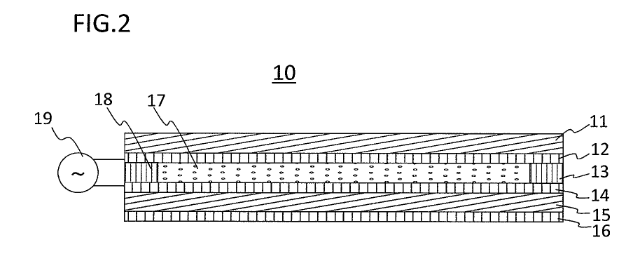

The liquid crystal display device 10 displays monochrome images. The liquid crystal display device 10 will be described with reference to FIG. 2.

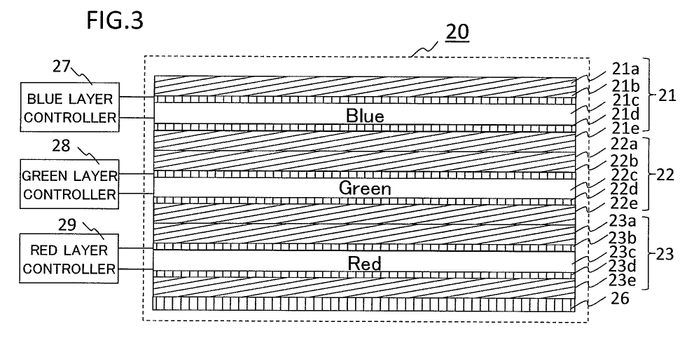

While the display apparatus 30 in FIG. 1 includes the liquid crystal display device 10, the display apparatus 30 may include a liquid crystal display device 20, which will be describe later with reference to FIG. 3, in place of the liquid crystal device 10.

The driving circuit 40 includes the liquid crystal display device 10, a power supply 31, a voltage booster 32, a voltage changer 33, a voltage stabilizer 34, a master clock circuit 35, a frequency divider 36, a control circuit 37, a common driver 38, and a segment driver 39. The driving circuit 40 is a circuit that receives image data 50 and causes the liquid crystal display device 10 to display an image. The image data 50 is image data representing an image to be displayed on the liquid crystal display device 10.

The power supply 31 outputs voltages in the range of 3 V to 5 V, for example. The voltage booster 32 uses a regulator such as a DC-DC converter to increase a voltage input from the power supply 31 to a voltage in the range of +36 V to +40 V. The voltage changer 33 divides an output voltage provided from the voltage booster 32 by using resistances to generate different voltage levels. The voltage stabilizer 34, which may be a voltage follower circuit using an operational amplifier, for example, stabilizes voltages of different levels provided from the voltage changer 33.

The master clock circuit 35 generates a base clock on which the operation of the display apparatus 30 is based. The frequency divider 36 divides the frequency of the base clock to generate various clocks requested for operation of the display apparatus 30, which will be described later.

The control circuit 37 generates various control signals (line selection data LS 41, a data strobe clock CLK 42, a frame start signal FST 43, a pulse polarity control signal FR 44, a line latch signal LLP 45, a data latch signal DLP 46, and a driver output off signal/DSPOF 47) and display data 48 on the basis of the base clock, the various clocks and image data 50 and provides these signals to the common driver 38 and the segment driver 39.

Accordingly, the control circuit 37 acts as a directing circuit that selects pulse types, including +12-V pulse and −12-V pulse, and pulse duties for the two pulses according to gray levels of the pixels of the liquid crystal display device 10 or the liquid crystal display device 20 and indicates the result of the selection to the voltage drivers, as will be described later.

The line selection data LS 41 indicates a scan line to which the common driver 38 applies a preparation pulse, a selection pulse and an evolution pulse.

The data strobe clock CLK 42 is a clock used by the common driver 38 and the segment driver 39 to transfer line selection data LS 41 and display data 48 within them.

The frame start signal FST 43 is a signal indicating the start of transfer of display data 48 for a display screen to be refreshed. The common driver 38 and the segment driver 39 reset themselves in response to the frame start signal FST 43.

The pulse polarity control signal FR 44 is a signal that reverses the polarity of an applied voltage at the intermediate time point during a write on one line. The common driver 38 and the segment driver 39 reverse the polarity of an output signal according to the pulse polarity control signal FR 44.

The line latch signal LLP 45 is a signal indicating the end of transfer of line selection data in the common driver 38. Line selection data LS41 transferred is latched in response to the line latch signal LLP 45.

The data latch signal DLP 46 is a signal indicating the end of transfer of display data 48 to the segment driver 39. The transferred display data 48 is latched in response to this signal. The driver output off signal/DSPOF 47 is a forced-OFF signal that forcedly turns off an application of a voltage. The display data 48 is data to be sent to the segment driver 39 to cause the liquid crystal display device 10 to display a gray-scale image and includes a gray level code. The common driver 38 drives voltages corresponding to the preparation pulse, the selection pulse and the evolution pulse to data electrodes. When receiving the gray level code, the segment driver 39 drives a voltage corresponding to the gray level of an element of the liquid crystal display device 10.

FIG. 2 illustrates a cross-sectional structure of the cholesteric liquid crystal display device 10 included in the display apparatus of the present embodiment. The liquid crystal display device 10 is a liquid crystal display device that displays monochrome images. The liquid crystal display device 10 includes an absorption layer 16, a lower transparent substrate 15, a lower electrode layer 14, sealants 18 and 13, a cholesteric liquid crystal layer 17, an upper electrode layer 12, and an upper transparent substrate 11. A driving circuit 19 drives the liquid crystal display device 10. The driving circuit 19 is similar to the driving circuit 40 in FIG. 1 and therefore, description of the driving circuit 19 will be omitted.

The upper transparent substrate 11 and the lower transparent substrate 15 are light-transmissive glass substrates. However, if monochrome images are displayed, the lower glass substrate may be opaque. While the upper and lower transparent substrates 11 and 15 are made of glass in this example, they may be non-glass light-transmissive film substrates such as polyethylene terephthalate (PET) or polycarbonate (PC). Spacers that make the gap between the upper and lower transparent substrates 11 and 15 uniform may be provided between the upper and lower transparent substrates 11 and 15. The spacers are preferably adherent spacers made of a resin or an inorganic oxide or coated with a thermoplastic resin, for example. The spacers are spherical and the gap formed by the spacers between the upper and lower transparent substrates 11 and 15 is preferably in the range of 4 to 6 μm, exclusive. If the gap is 4 μm or less, the reflectance of the cholesteric liquid crystal layer 17 will be low and accordingly, the display of the liquid crystal display device 10 will be dark and the display will not exhibit steep threshold response characteristics. On the other hand, if the gap is greater than or equal to 6 μm, the display will exhibit sharp threshold response characteristics but will request higher driving voltages to provide a display, which will make it difficult to use off-the-shelf components to drive.

The upper electrode layer 12 and the lower electrode layer 14 are typically transparent conductive films of indium tin oxide (ITO). However, the upper and lower electrode layers 12 and 14 may be transparent conductive films made of other materials such as indium zinc oxide (IZO).

The upper electrode layer 12 is formed on the upper transparent substrate 11 and includes multiple strip-shaped transparent electrodes arranged in parallel to one another.

The lower electrode layer 14 is formed on the lower transparent substrate 15 opposed to the upper transparent substrate 11 and includes multiple strip-shaped transparent electrodes arranged in parallel to one another. The strip-shaped transparent electrodes in the lower electrode layer 14 extend in a direction intersects with the direction in which the strip-shaped transparent electrodes in the upper electrode layer 12 extend, when viewed from the direction perpendicular to the plane in which the upper transparent substrate 11 and the lower transparent substrate 15 are opposed to each other.

An insulating thin-film layer is formed between the cholesteric liquid crystal layer 17 and the upper electrode layer 12 and between the cholesteric liquid crystal layer 17 and the lower electrode layer 14. Each of the insulating thin-film layers is preferably approximately 0.3 μl thick. If the insulating thin-film layers are thicker, higher driving voltages will be requested for providing a display. On the other hand, if the insulating thin-film layers are thinner, more leak current will pass through the insulating thin film layers and therefore, more current will be consumed. The insulating thin-film layers may be silicon oxide thin-films or organic films such as polyimide resin films or acrylic resin films, which are known as orientation stabilizing films. The specific permittivity of these films is on the order of 5, for example.

The cholesteric liquid crystal layer 17 is disposed in the gap between the upper transparent substrate 11 and the lower transparent substrate 15 and shielded in the gap with the sealants 18 and 13 provided at the edges of the upper transparent substrate 11 and the lower transparent substrate 15. The cholesteric liquid crystal layer 17 is made of a nematic liquid crystal mixture with a 10 to 40 weight percent (wt %) of chiral material added. Here, the amount of the chiral material is a value based on 100 wt % of the total amount of the nematic liquid crystal components plus the chiral material. The nematic liquid crystal mixture may be any of known ones. Preferably, the nematic liquid crystal mixture is a material having a dielectric anisotropy (Δ∈) in the range of 15 to 25, exclusive. If the dielectric anisotropy (Δ∈) is less than or equal to 15, higher driving voltages will be requested for providing a display, which will make it difficult to use off-the-shelf components to drive. On the other hand, if the dielectric anisotropy is greater than or equal to 25, the steepness of threshold response of the display will be low and the reliability of the liquid crystal itself will be low.

The refractive index anisotropy (Δn) of the nematic liquid crystal mixture is preferably in the range of 0.18 to 0.26. If the refractive index anisotropy (Δn) is less than 0.18, the reflectance of the cholesteric liquid crystal layer 17 in a planar state will be low. On the other hand, if the refractive index anisotropy (Δn) exceeds 0.26, scatter reflections in a focal conic state will be large. If the chiral material is added to the nematic liquid crystal mixture so that the refractive index anisotropy (Δn) exceeds 0.26, the viscosity of the cholesteric liquid crystal layer 17 will increase and the display response speed will decrease.

The absorption layer 16 is disposed on the outer surface of the lower transparent substrate 15, located opposite from the light incident surface. The absorption layer 16 is a layer that absorbs visible light and blocks visible light incident from the outer surface of the lower transparent substrate 15.

While the liquid crystal display device 10 included in the display apparatus 30 of the embodiment in FIG. 1 is a monochrome liquid crystal display device that displays monochrome images, the display apparatus 30 of the present embodiment may include a liquid crystal display device 20 that displays color images using three primary colors: red, green and blue, instead of the monochrome liquid crystal display device 10.

FIG. 3 illustrates a cross-sectional structure of a cholesteric liquid crystal display device 20. The liquid crystal display device 20 includes display elements capable of displaying color images. The liquid crystal display device 20 includes cholesteric liquid crystal panels 21, 22 and 23 corresponding to RGB, that is, red (approximately 630 nm), green (approximately 550 nm) and blue (approximately 480 nm), stacked on one another. Each of the cholesteric liquid crystal panels 21, 22 and 23 includes an upper transparent substrate 21a, 22a, 23a, an upper electrode layer 21b, 22b, 23b, a cholesteric liquid crystal layer 21c, 22c, 23c, a lower electrode layer 21d, 22d, 23d, and a lower transparent substrate 21e, 22e, 23e. An absorption layer 26 is disposed under the cholesteric liquid crystal panel 23.

The liquid crystal display device 20 is an A4-sized XGA display including 1024×768 pixels. Here, 1024 data electrodes and 768 scan electrodes are provided and the segment driver 39 drives the 1024 data electrodes and the common driver 38 drives the 768 scan electrodes. Since different pieces of display data are provided to pixels of the different colors RGB, the segment driver 39 and the common driver 38 included in each of a blue layer controller 27, a green layer controller 28 and a red layer controller 29 independently drive their respective data electrodes. The scan line associated with the scan electrode at the top of the screen is referred to as the 0th line and the line associated with the scan electrode at the bottom of the screen is referred to as the 767th line.

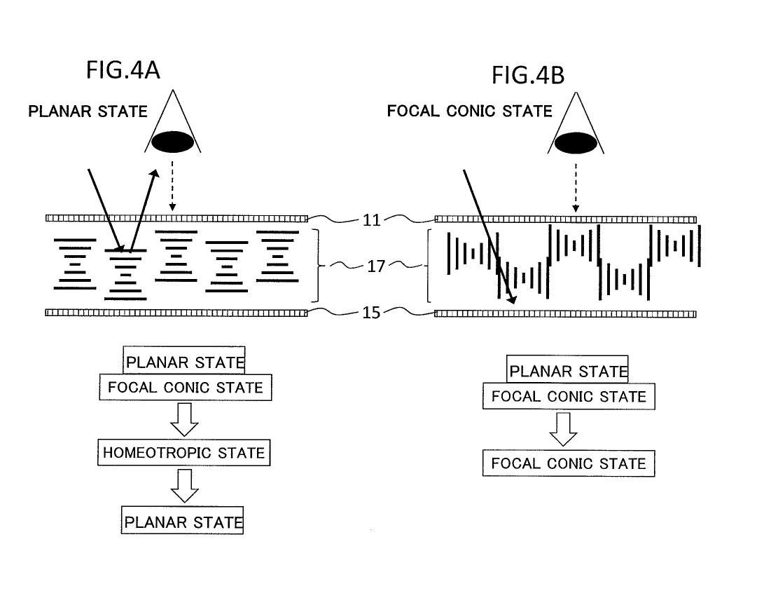

FIGS. 4A and 4B are diagrams illustrating bistability of a cholesteric liquid crystal. The liquid crystal display device 10 illustrated in FIGS. 4A and 4B includes an upper transparent substrate 11, a lower transparent substrate 15, and a cholesteric liquid crystal layer 17. The black arrows in FIGS. 4A and 4B represent incident light or reflected light.

The cholesteric liquid crystal has two stable states; a planar state and a focal conic state. When a strong electric field is applied to the cholesteric liquid crystal, the cholesteric liquid crystal transforms into a homeotropic state in which all liquid crystal molecules point in the direction of the electric field. When the application of the electric charge is stopped subsequently, the cholesteric liquid crystal transforms into the planar state illustrated in FIG. 4A or in the focal conic state illustrated in FIG. 4B.

The planar state is a state in which liquid crystal molecules are helically twisted along the direction perpendicular to the upper transparent substrate 11 and the lower transparent substrate 15 in the cholesteric liquid crystal. Accordingly, incident light is reflected by the helically twisted liquid crystal molecules. The wavelength λ of light at which reflection intensity peaks in the planar state may be given by

λ=n×P

where n is the average refractive index of the liquid crystal and p is the helical pitch.

The focal conic state is a state in which the liquid crystal molecules are helically twisted along the direction horizontal to the upper transparent substrate 11 and the lower transparent substrate 15 in the cholesteric liquid crystal. Accordingly, almost all incident light is not reflected but reaches the lower transparent substrate 15 and is absorbed in the absorption layer under the lower transparent substrate 15.

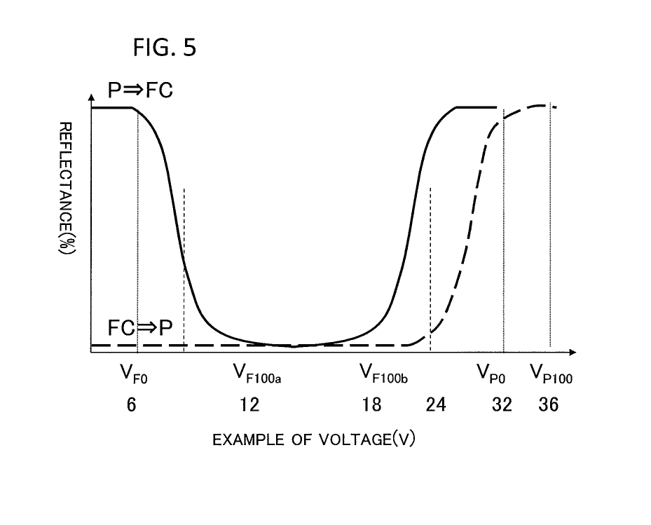

FIG. 5 illustrates an example of voltage versus reflectance characteristics of a typical cholesteric liquid crystal. The horizontal axis represents the pulse voltage (V) applied between electrodes sandwiching the cholesteric liquid crystal with a predetermined pulse width. The vertical axis represents the reflectance (%) of the cholesteric liquid crystal. Solid curve P in FIG. 5 represents voltage versus reflectance characteristics of the cholesteric liquid crystal the initial state of which is a planer state. Dashed curve FC represents voltage versus reflectance characteristics of the cholesteric liquid crystal the initial state of which is a focal conic state.

When a strong electric field (greater than or equal to Vₚ 100) is applied to the cholesteric liquid crystal, the helically twisted liquid crystal molecules are completely untwisted and the cholesteric liquid crystal transforms into a homeotropic state in which all the molecules point in the direction of the electric field while the electric field is being applied. Then, when the applied voltage is rapidly dropped from Vₚ100 to a predetermined low voltage (for example V_{F}) to rapidly reduce the electric field in the liquid crystal in the homeotropic state to nearly 0, the helical axes of the molecules of the liquid crystal point perpendicular to the electrodes and the liquid crystal transforms into a planar state in which the liquid crystal selectively reflects light according to the helical pitch.

On the other hand, when a weak electric field (in the range of V_{F}100a to V_{F}100b) that does not untwist the helically twisted cholesteric liquid crystal molecules is applied and then the electric field is removed, or when a strong electric field is applied and then the electric field is gradually removed, the helical axes of the cholesteric liquid crystal molecules are aligned in parallel to the electrodes and the cholesteric liquid crystal transforms into the focal conic state in which the cholesteric liquid crystal reflects incident light.

When a medium electric field (in the range of V_{F}0 to V_{F}100a or V_{F}100b to Vₚ0) is applied and then the electric field is rapidly removed, some of the liquid crystal molecules are placed in the planer state and the others are in the focal conic state. Thus, a gray-level display may be accomplished.

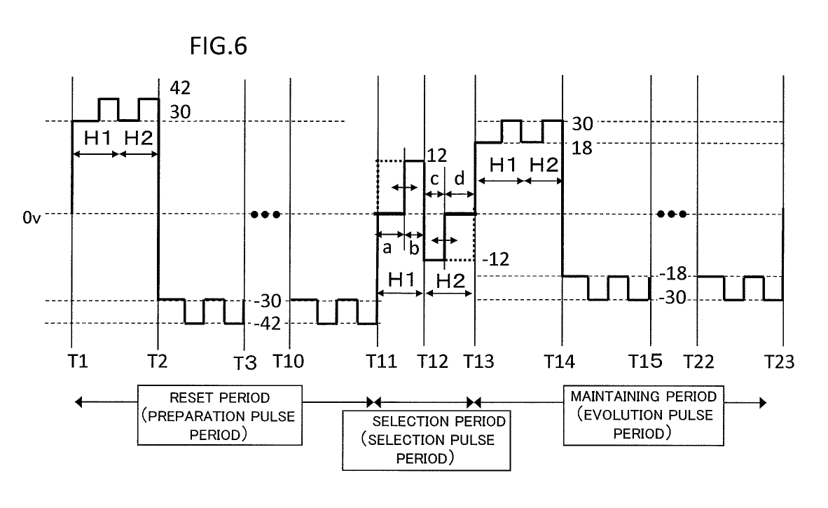

FIG. 6 is a diagram illustrating dynamic driving of a cholesteric liquid crystal in the present embodiment.

Driving pulses used for the dynamic driving in the present embodiment include a preparation pulse, a pulse-width modulated (PWM) selection pulse, and an evolution pulse. The common driver 38 performs control to connect a +15-V voltage driver, a ground (GND) voltage driver, a −9-V voltage driver, a −15-V voltage driver, or a −21-V voltage driver to a scan electrode. The segment driver 39 performs control to connect a +21-V voltage driver or a +9-V voltage driver to a segment electrode.

The preparation pulse is a pulse for applying a strong electric field to the cholesteric liquid crystal to cause a homeotropic state as has been described with respect to FIG. 5.

The average pulse voltage of the preparation pulse is preferably greater than or equal to Vₚ0 (32 V) in FIG. 5. Therefore, the common driver 38 connects the −21-V voltage driver to the scan electrode and the segment driver 39 connects the +21-V voltage driver or the +9-V voltage driver to the segment electrode.

In a reset period (also referred to as the preparation pulse period and is the period between time T1 and time T11 in FIG. 6), a pair of a positive pulse indicated in the period between time T1 and time T2 and a negative pulse indicted in the period between time T2 and time T3 is applied continuously 10 times. That is, 10 pulses are sequentially applied to one line of the cholesteric liquid crystal. The positive pulse has a peak voltage in the range of 30 V to 42 V. The negative pulse has a valley voltage in the range of −30 V to −42 V. The positive pulse includes a first 30-V period and a first 42-V period in period H1, and includes a second 30-V period and a second 42-V period in period H2. Similarly, the negative pulse includes a first −30-V period and a first −42-V period and a second −30-V period and a second −42-V period. The voltages change in this way because different voltages are applied between the segment electrode and the scan electrode depending on which of the 21-V voltage driver and the 9-V voltage driver is connected to the segment electrode.

Consequently, the ratio of the first 30-V period to the second 42-V period is a:b; the ratio of the second 30-V period to the second 42-V period is c:d, where a, b, c and d will be described later in conjunction with description of the selection pulses.

The negative pulse includes the first −30-V period and the first −42-V period. The ratio of the first −30-V period to the second −42-V period is a:b. The ratio of the second −30-V period to the second −42V-period is c:d.

The pulse-width modulated selection pulse is a pulse that applies a medium or low electric field to the cholesteric liquid crystal to trigger transition to the planer state, the focal conic state or the state in which the planer and focal conic states coexist. In order to generate the selection pulse, the segment driver 39 connects the +21-V voltage driver or the +9-V voltage driver to the segment electrode; the common driver 38 connects the +9-V voltage driver to the scan electrode. When the +9-V voltage driver is connected to the segment electrode and the +9-V voltage driver is connected to the scan electrode, the voltage between the two electrodes becomes 0 V.

In period “a” in period H1 (the period between time T11 and time T12) in a selection period (also referred to as the selection pulse period and is the period between time T11 and time T13), the pulse-width-modulated selection pulse wave is at 0V. The pulse-width-modulated selection pulse wave is at 12 V in period “b”. The pulse-width-modulated selection pulse wave is at 12 V in period “c” in period H2 (the period between time T12 and time T13) and at 0 V in period “d”. That is, a pair of selection pulses with the same pulse width and the same pulse voltage but different polarities are applied to the scan electrode in periods H1 and H2. While the voltage in the pulse periods is 12 V, the voltage may be any predetermined constant voltage.

The selection pulses have O-V periods depicted in FIG. 5, in addition to the +12 and −12-V periods described above. By changing the ratio between the 12-V and 0-V time periods, the ratio between molecules in the homeotropic state and molecules in the transient planer state may be changed to allow the cholesteric liquid crystal to produce a gray-level display.

The evolution pulse is a pulse that ultimately determines the state of the cholesteric liquid crystal. The evolution pulse determines the state of portions of the cholesteric liquid crystal that have been undetermined after the application of the selection pulses. The average voltage of the evolution pulse is preferably in the range of V_{F}100b (18 V) to V_{P}0 (32 V) in FIG. 5. The segment driver 39 connects the +21-V voltage driver or the +9-V voltage driver to the segment electrode. The common driver 38 connects the −9-V voltage driver to the scan electrode.

In a maintaining period (also referred to as the evolution pulse period and is the period between time T13 and time T23), a pair of a positive pulse indicated in the period between time T13 and time T14 and a negative pulse indicted in the period between time T14 and time T15 is applied continuously 10 times. That is, 10 pulses are sequentially applied to one line of the cholesteric liquid crystal.

The positive pulse has a peak voltage in the range of 18 V to 30 V. The negative pulse has a valley voltage in the range of −18 V to −30 V. The positive pulse includes a first 18-V period and a first 30-V period in period H1 and includes a second 18-V period and a second 30-V period in period H2. Similarly, the negative pulse includes a first −18-V period and a first −30 period and a second −18-V period and a second −30 period. The ratio of the first 18-V period to the second 30-V period is a:b. The ratio of the second 18-V period to the second 30-V period is c:d. Here, a, b, c and d are as described in the description of the selection pulse.

The negative pulse includes the first −18-V period, the first −30 period, the second −18-V period, and the second −30 period. The ratio of the first −18-V period to the second −30-V period is a:b. The ratio of the second −18-V period to the second −30-V period is c:d.

The voltage changes in this way because different voltages are applied between the segment electrode and the scan electrode depending on which of the 21-V voltage driver and the 9-V voltage is connected to the segment electrode.

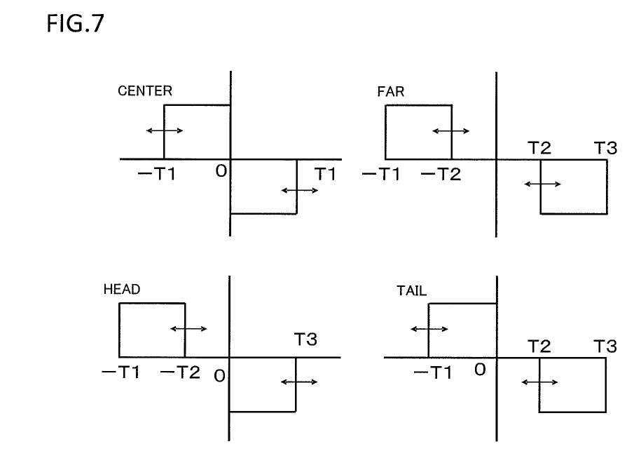

FIG. 7 illustrates the types of pairs of pulses that may be used as the selection pulses illustrated in FIG. 6. Each pair of selection pulses has the same pulse duty and pulse voltage but different polarities. A type of pulses is a type classified as a group according to the relationship between the start points of two pulses, such as those described above, and the origin of the pair, that is, a type classified as a group according to the positional relationship between two pulses and the direction of pulse-width modulation for changing pulse duties. A pulse duty is the ratio between the pulse period of a pulse signal and a 0-V period.

Center-type pulses illustrated in FIG. 7 include a positive pulse that starts at time −T1 and ends at time 0 and a negative pulse that starts at time 0 and ends at time T1, where T1 is an arbitrary time instant. The assumption that the start time of the positive pulse is −T1 and the end time of the negative pulse is T1 implies that the start and end times are linked together. That is, the pulse width of the positive pulse has been modulated in the positive direction and the pulse width of the negative pulse has been modulated in the negative direction. For the Center-type pulses, a 0-V period in which the positive and negative pulses are absent is between a preparation pulse and the positive pulse and between the negative pulse and an evolution pulse.

Far-type pulses illustrated in FIG. 7 include a positive pulse that starts at time −T1 and ends at time −T2 and a negative pulse that starts at time T2 and ends at time T3. Here, T1, T2 and T3 are arbitrary time instants. The assumption that the end time of the positive time is −T2 and the start time of the negative pulse is T2 implies that the end and start times are linked together. That is, the pulse width of the positive pulse has been modulated in the negative direction and the pulse width of the negative pulse has been modulated in the positive direction. For the Far-type pulses, a O-V period in which the positive and negative pulses are absent is between a preparation pulse and the positive pulse and between the negative pulse and an evolution pulse.

Head-type pulses illustrated in FIG. 7 include a positive pulse that starts at time −T1 and ends at time −T2 and a negative pulse that starts at time 0 and ends at time T3. Here, T1, T2 and T3 are arbitrary time instants. The time period between the end time −T1 of the positive pulse and time −T2 and the time period between the start time 0 of the negative pulse and time T3 are linked together. That is, the pulse width of the positive pulse is modulated in the positive direction and the pulse width of the negative pulse is modulated in the positive direction. For the Head-type pulses, a O-V period in which the positive and negative pulses are absent is between the positive pulse and the negative pulse and between the negative pulse and an evolution pulse.

Tail-type pulses illustrated in FIG. 7 includes a positive pulse that starts at time −T1 and ends at time 0 and a negative pulse that starts at time T2 and ends at time T3. Here, T1, T2 and T3 are arbitrary time instants. The time period between the end time −T1 of the positive pulse and time 0 and the time period between the start time T2 of the negative pulse and time T3 are liked together. That is, the pulse width of the positive pulse is modulated in the negative direction and the pulse width of the negative pulse is modulated in the negative direction. For the Tail-type pulses, a O-V period in which the positive and negative pulses are absent is between a preparation pulse and the positive pulse and between the positive pulse and the negative pulse.

While the 0-V periods given above are periods during which the applied voltage is 0 V, the voltage does not necessarily need to be 0 V; the voltage may be on the order of V_{F}0 (6 V) as in FIG. 5.

The pulse voltage of a selection pulse set as any of the Center type, Far type, Head type and Tail type is +12 V or −12 V, which does not transform a cholesteric liquid crystal from a homeotropic state into a planer or focal conic state.

However, since the period during which a voltage equal to or lower than V_{F}0 illustrated in FIG. 5 (approximately 0 V in FIG. 7) is applied is provided between the +12-V pulse and the −12-V pulse, between the preparation pulse and the +12-V pulse, and between the −12-V pulse and the evolution pulse, portions of the cholesteric liquid crystal are transformed from the homeotropic state into the planer or focal conic state. Consequently, the cholesteric liquid crystal provides a gray-level display.

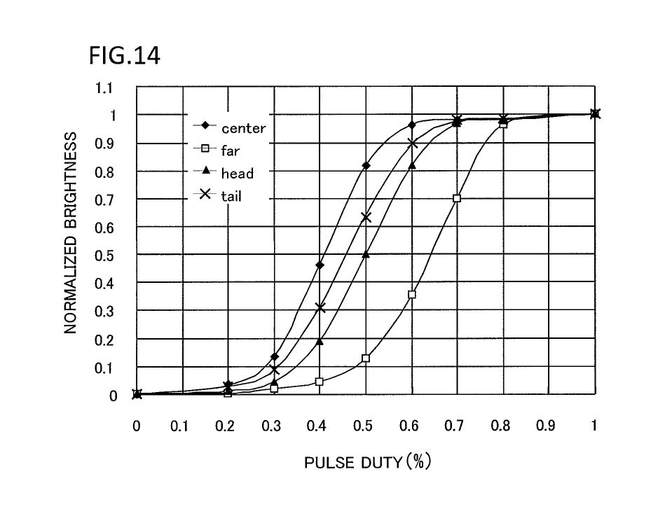

As illustrated in FIG. 14 and described later, even though the pulse widths are the same, different pulse types applied to the cholesteric liquid crystal produce different levels of gray. That is, even though the pulse duties of the pulses applied are the same, different levels of gray are produced in the cholesteric liquid crystal.

The reason seems to be that the extent to which the cholesteric liquid crystal transforms from the homeotropic state into the planer or focal conic state varies depending on where the periods during which the voltage V_{F}0 in FIG. 5 (approximately 0 V in FIG. 7) is applied are located in the selection pulses.

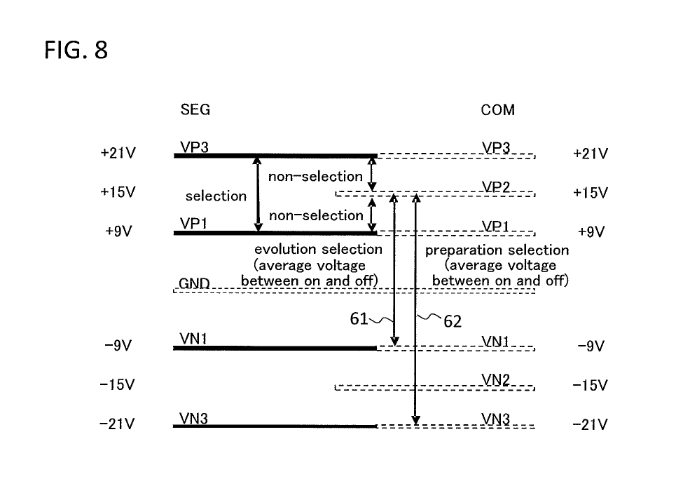

FIG. 8 illustrates voltage drivers requested for producing preparation, selection and evolution pulses.

The voltage drivers illustrated in FIG. 8 are +21-V voltage drivers, +15-V voltage drivers, +9-V voltage drivers, a ground (GND) voltage driver, −9-V voltage drivers, −15-V voltage drivers, and −21-V voltage drivers. The voltage drivers in FIG. 8 drive voltages that produce preparation, selection, and evolution pulses.

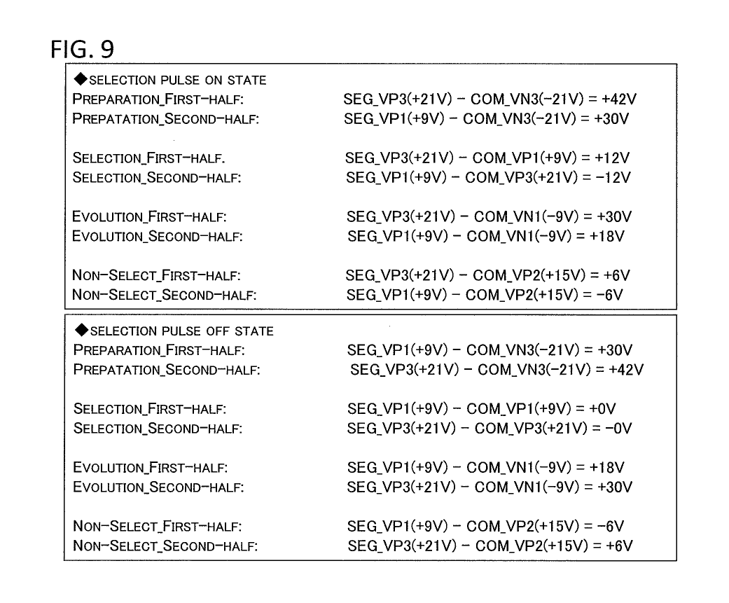

FIG. 9 illustrates combinations of the voltage drivers for generating voltages for the preparation, selection and evolution pulses.

Voltages of 42 V and −42 V of the preparation pulse are generated by the +21-V voltage driver and the −21-V voltage driver. A voltage of 30 V is generated by the +21-V voltage driver and the −9-V voltage driver and a voltage of −30 V is generated by the −21-V voltage driver and the 9-V voltage driver. Then, the average voltage of the preparation pulse is 36 V as indicated by arrow 61 in FIG. 8.

Voltages of 18 V and −18 V of the evolution pulse are generated by the +9-V voltage driver and −9-V voltage driver. Voltages of 30 V and −30 V are generated in the same way as in the preparation pulse. Then, the average voltage of the evolution pulse is 24 V as indicated by arrow 62 in FIG. 8.

Voltages of 12 V and −12 V of the selection pulse are generated by the +21-V voltage driver and +9-V voltage driver. A voltage of 0 V is generated by the +9-V voltage drivers and a voltage of −0 V is generated by the +21-V voltage drivers.

Any of the selection pulses are in a dissected while they are not applied to the cholesteric liquid crystal, and a voltage of +6 V or −6 V is applied instead. The +6-V voltage is generated by the +21-V voltage driver and the +15-V voltage driver. The −6-V voltage is generated by the +9-V voltage driver and the +15-V voltage driver.

The “Selection pulse ON” state in FIG. 9 is a state in which the selection pulse is maintained at +12 V in period H1 in FIG. 6 and a state in which the selection pulse is maintained at −12 V in period H2. When the selection pulse is set to an ON condition as will be described later, the brightness of the cholesteric liquid crystal reaches its peak, that is, white. The “Selection pulse OFF” state in FIG. 9, on the other hand, is a state in which the selection pulse is maintained at 0 V in period H1 and period H2. When the selection pulse is set to an OFF condition as will be described later, the brightness of the cholesteric liquid crystal decreases to its minimum, that is, black.

Selection First-half in FIG. 9 is period H1 in the selection pulse period in FIG. 6 and Selection Second-half is period H2 in FIG. 6. Preparation First-half is the first half of the period between time T1 and T2 in FIG. 6 and Preparation Second-half is the next half of the period. When the selection pulse is ON, the preparation pulse is maintained at +42 V during the Preparation First-half and maintained at +30 V during the Preparation Second-Half. On the other hand, when the selection pulse is OFF, the preparation pulse is maintained at +30 V during the Preparation First-half and maintained at +42 V during the Preparation Second-half.

Evolution First-half in FIG. 9 is the first half of the period between time T13 and T14 in FIG. 6 and Evolution Second-half is the next half of the period. When the selection pulse is ON, the evolution pulse is maintained at +30 V during the Evolution First-half and maintained at +18 V during the Evolution Second-half. When the selection pulse is OFF, the evolution pulse is maintained at +18 V during the Evolution First-half and maintained at +30 V during the Evolution Second-half.

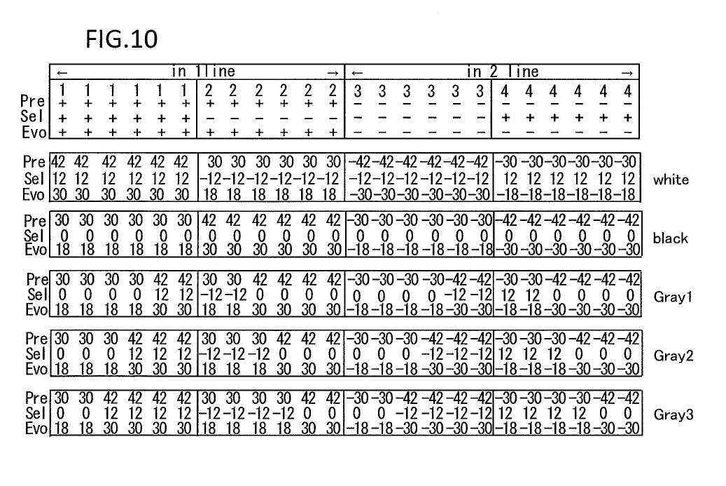

While the polarity of the preparation pulse and the evolution pulse is reversed on every line in FIG. 10, it is desirable in practice that the polarity of the preparation pulse and the evolution pulse be reverse on every several lines, in order to conserve power consumption.

Non-Selection First-half in FIG. 9 is a non-selection state, which corresponds to period H1 in FIG. 6. Selection Second-half is a non-selection state, which corresponds to period H2 in FIG. 6.

FIG. 10 illustrates exemplary states of the preparation, selection and evolution pulses when the selection pulse of the Center type is used.

FIG. 10 illustrates the voltage or polarity of the preparation pulse in a period equivalent to the period between time T1 and time T2, the voltage or polarity of the selection pulse in a period equivalent to the period between time T11 and time T13, and the voltage or polarity of the evolution pulse in a period equivalent to the period between time T13 and time T14. That is, the first or second line is displayed in the periods equivalent to the period between time T1 and time T2, the period between time T11 and T13 or the period between time T13 and T14 and each of the periods includes 12 clock cycles.

In the top part of FIG. 10, the polarities of the preparation pulse, the selection pulse and the evolution pulse are positive in the first half of the first line; the polarities of the preparation pulse and the evolution pulse are positive but the polarity of the selection pulse is negative in the second half of the first line. The polarities of the preparation pulse, the selection pulse and the evolution pulse are negative in the first half of the second line; the polarity of the preparation pulse and the evaluation pulse are negative but the polarity of the selection pulse is positive in the second half of the second line. The polarities of the preparation pulse, the selection pulse and the evolution pulse may be changed in every clock cycle.

The second part from the top of FIG. 10 illustrates the voltages of the preparation pulse, the selection pulse and the evolution pulse for causing the cholesteric liquid crystal to display white.

In the first half of the first line, the preparation pulse is at 42V, the selection pulse is at 12 V and he evolution pulse is at 30 V. In the second half of the first line, the preparation pulse is at 30 V, the selection pulse is at −12 V, and the evolution pulse is at 18 V. In the first half of the second line, the preparation pulse is at −42 V, the selection pulse is at −12 V, and the evolution pulse is at −30 V. In the second half of the second line, the preparation pulse is at −30 V, the selection pulse is at 12 V and the evolution pulse is at −18 V.

The third part from the top of FIG. 10 illustrates the voltages of the preparation pulse, the selection pulse and the evolution pulse for causing the cholesteric liquid crystal to display black.

In the first part of the first line, the preparation pulse is at 30 V, the selection pulse is at 0 V, and the evolution pulse is at 18 V. In the second half of the first line, the preparation pulse is at 42 V, the selection pulse is at 0 V, and the evolution pulse is at 30 V. In the first half of the second line, the preparation pulse is at −30 V, the selection pulse is at 0 V, and the evolution pulse is at −18 V. In the second half of the second line, the preparation pulse is at −42 V, the selection pulse is at 0 V, and the evolution pulse is at −30 V.

The fourth part from the top of FIG. 10 illustrates the voltages of the preparation pulse, the selection pulse and the evolution pulse for causing the cholesteric liquid crystal to display a whitish gray.

In the first part of the first line, the preparation pulse is at 30 V during the first 4 clock cycles and at 42 V during the next 2 clock cycles. The selection pulse is at 0 V during the first 4 clock cycles and at 12 V during the next 2 clock cycles. The evolution pulse is at 18 V during the first 4 clock cycles and at 30 V during the next 2 clock cycles. In the second half of the first line, the preparation pulse is at 30 V during the first 2 clock cycles and at 42 V during the next 4 clock cycles. The selection pulse is at −12 V during the first 2 clock cycles and at 0 V during the next 4 clock cycles. The evolution pulse is at 18 V during the first 2 clock cycles and 30 V during the next 4 clock cycles. In the first half of the second line, the preparation pulse is at −30 V during the first 4 clock cycles and at −42 V during the next 2 clock cycles. The selection pulse is at 0 V during the first 4 clock cycles and at −12 V during the next 2 clock cycles. The evolution pulse is at −18 V during the first 4 clock cycles and 30 V during the next 2 clock cycles. In the second half of the second line, the preparation pulse is at −30 V during the first 2 clock cycles and at −42 V during the next 4 clock cycles. The selection pulse is at 12 V during the first 2 clock cycles and at 0 V during the next 4 clock cycles. The evolution pulse is at −18 V during the first 2 clock cycles and at −30 V during the next 4 clock cycles.

The fifth part from the top of FIG. 10 illustrates the voltages of the preparation pulse, the selection pulse and the evolution pulse for causing the cholesteric liquid crystal to display a gray intermediate between white and black. In the first half of the first line, the preparation pulse is at 30 V during the first 3 clock cycles and at 42 V during the next 3 clock cycles. The selection pulse is at 0 V during the first 3 clock cycles and at 12 V during the next 3 clock cycles. The evolution pulse is at 18 V during the first 3 clock cycles and at 30 V during the next 3 clock cycles. In the second half of the first line, the preparation pulse is at 30 V during the first 3 clock cycles and at 42 V during the next 3 clock cycles. The selection pulse is at −12 V during the first 3 clock cycles and at 0 V during the next 3 clock cycles. The evolution pulse is 18 V during the first 3 clock cycles and 30 V during the next 3 clock cycles. In the first half of the second line, the preparation pulse is at −30 V during the first 3 clock cycles and −42 V during the next 3 clock cycles. The selection pulse is 0 V during the first 3 clock cycles and at −12 V during the next 3 clock cycles. The evolution pulse is at −18 V during the first 3 clock cycles and at −30 V during the next 3 clock cycles. In the second half of the second line, the preparation pulse is at −30 V during the first 3 clock cycles and at −42 V during the next 3 clock cycles. The selection pulse is at 12 V during the first 3 clock cycles and at 0 V during the next 3 clock cycles. The evolution pulse is at −18 V during the first 3 clock cycles and at −30 V during the next 3 clock cycles.

The sixth part from the top of FIG. 10 illustrates the voltages of the preparation pulse, the selection pulse and the evolution pulse for causing the cholesteric liquid crystal to display a blackish gray.

In the first half of the first line, the preparation pulse is at 30 V during 2 clock cycles and at 42 V during 4 clock cycles. The selection pulse is at 0 V during the first 2 clock cycles and at 12 V during the next 4 clock cycles. The evolution pulse is at 18 V during the first 2 clock cycles and at 30 V during the next 4 clock cycles. In the second half of the first line, the preparation pulse is at 30 V during the first 4 clock cycles and at 42 V during the next 2 clock cycles. The selection pulse is at −12 V during the first 4 clock cycles and at 0 V during the next 2 clock cycles. The evolution pulse is at 18 V during the first 4 clock cycles and at 30 V during the next 2 clock cycles. In the first half of the second line, the preparation pulse is at −30 V during the first 2 clock cycles and at −42 during the next 4 clock cycles. The selection pulse is at 0 V during the first 2 clock cycles and at −12 V during the next 4 clock cycles. The evolution pulse is at −18 V during the first 2 clock cycles and at −30 V during the next 4 clock cycles. In the second half of the second line, the preparation pulse is at −30 V during the first 4 clock cycles and at −42 V during the next 2 clock cycles. The selection pulse is at 12 V during the first 4 clock cycles and at 0 V during the next 2 clock cycles. The evolution pulse is at −18 V during the first 4 clock cycles and at −30 V during the next 2 clock cycles.

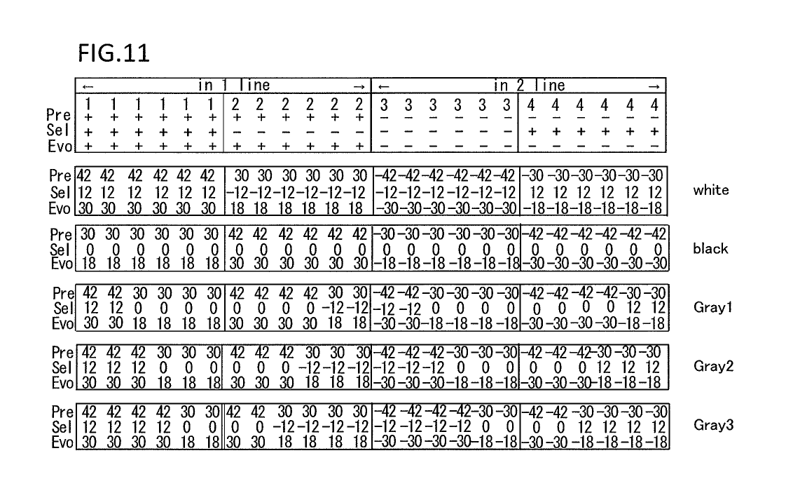

FIG. 11 illustrates exemplary states of preparation, selection and evolution pulses when the selection pulse of the Far type is used. The states of the pulses on the first and second lines in FIG. 11 are the same as those on the first and second lines in FIG. 10 and therefore, description of those states will be omitted. The top, second, and third parts of FIG. 11 are the same as the top, second and third parts, respectively, of FIG. 10. This fact shows that in the case of Far type, the polarities of the preparation pulse, the selection pulse and the evolution pulse change in the same way as in the case of the Center type and that the voltages of the preparation pulse, the selection pulse and the evolution pulse for causing the cholesteric liquid crystal to display white or black change in the same way as in the case of the Center type.

The fourth part from the top of FIG. 11 illustrates the voltages of the preparation pulse, the selection pulse and the evolution pulse for causing the cholesteric liquid crystal to display a whitish gray.

In the first half of the first line, the preparation pulse is at 42 V during the first 2 clock cycles and at 30 V during the next 4 clock cycles. The selection pulse is at 12 V during the first 2 clock cycles and at 0 V during the next 4 clock cycles. The evolution pulse is at 30 V during the first 2 clock cycles and at 18 V during the next 4 clock cycles. In the second half of the first line, the preparation pulse is at 42 V during the first 4 clock cycles and at 30 V during the next 2 clock cycles. The selection pulse is at 0 V during the first 4 clock cycles and at −12 V during the next 2 clock cycles. The evolution pulse is at 30 V during the first 4 clock cycles and at 18 V during the next 2 clock cycles. In the first half of the second line, the preparation pulse is at −42 V during the first 2 clock cycles and at −30 V during the next 4 clock cycles. The selection pulse is at −12 V during the first 2 clock cycles and at 0 V during the next 4 clock cycles. The evolution pulse is at −30 V during the first 2 clock cycles and at −18 V during the next 4 clock cycles. In the second half of the second line, the preparation pulse is at −42 V during the first 4 clock cycles and at −30 V during the next 2 clock cycles. The selection pulse is at 0 V during the first 4 clock cycles and at 12 V during the next 2 clock cycles. The evolution pulse is at −30 V during the first 4 clock cycles and at −18 V during the next 2 clock cycles.

The fifth part from the top of FIG. 11 illustrates the voltages of the preparation pulse, the selection pulse and the evolution pulse for causing the cholesteric liquid crystal to display a gray intermediate between white and black.

In the first half of the first line, the preparation pulse is at 42 V during the first 3 clock cycles and at 30 V during the next 3 clock cycles. The selection pulse is at 12 V during the first 3 clock cycles and at 0 V during the next 3 clock cycles. The evolution pulse is at 30 V during the first 3 clock cycles and at 18 V during the next 3 clock cycles. In the second half of the first line, the preparation pulse is at 42 V during the first 3 clock cycles and at 30 V during the next 3 clock cycles. The selection pulse is at 0 V during the first 3 clock cycles and at 12 V during the next 3 clock cycles. The evolution pulse is at 30 V during the first 3 clock cycles and at 18 V during the next 3 clock cycles. In the first half of the second line, the preparation pulse is at −42 V during the first 3 clock cycles and at −30 V during the next 3 clock cycles. The selection pulse is at −12 V during the first 3 clock cycles and at 0 V during the next 3 clock cycles. The evolution pulse is at −30 V during the first 3 clock cycles and at −18 V during the next 3 clock cycles. In the second half of the second line, the preparation pulse is at −42 V during the first 3 clock cycles and at −30 V during the next 3 clock cycles. The selection pulse is at 0 V during the first 3 clock cycles and at 12 V during the next 3 clock cycles. The evolution pulse is at −30 V during the first 3 clock cycles and at −18 V during the next 3 clock cycles.

The sixth part from the top of FIG. 11 illustrates the voltages of the preparation pulse, the selection pulse and the evolution pulse for causing the cholesteric liquid crystal to display a blackish gray.

In the first half of the first line, the preparation pulse is at 42 V during the first 4 clock cycles and at 30 V during the next 2 clock cycles. The selection pulse is at 12 V during the first 4 clock cycles and at 0 V during the next 2 clock cycles. The evolution pulse is at 30 V during the first 4 clock cycles and at 18 V during the next 2 clock cycles. In the second half of the first line, the preparation pulse is at 42 V during the first 2 clock cycles and at 30 V during the next 4 clock cycles. The selection pulse is at −0 V during the first 2 clock cycles and at −12 V during the next 4 clock cycles. The evolution pulse is at 30 V during the first 2 clock cycles and at 18 V during the next 4 clock cycles. In the first half of the second line, the preparation pulse is at −42 V during the first 4 clock cycles and at −30 V during the next 2 clock cycles. The selection pulse is at −12 V during the first 4 clock cycles and at 0 V during the next 2 clock cycles. The evolution pulse is −30 V during the first 4 clock cycles and at −18 V during the next 2 clock cycles. In the second half of the second line, the preparation pulse is at −42 V during the first 2 clock cycles and at −30 V during the next 4 clock cycles. The selection pulse is at 0 V during the first 2 clock cycles and at 12 V during the next 4 clock cycles. The evolution pulse is at −30 V during the first 2 clock cycles and at −18 V during the next 4 clock cycles.

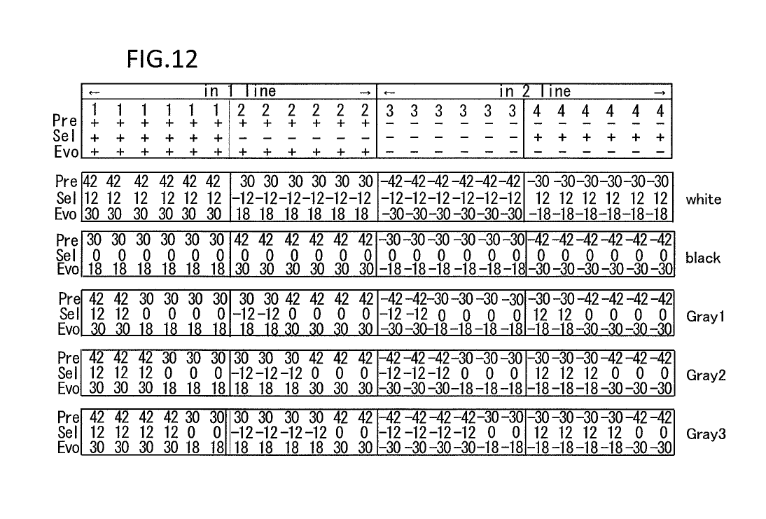

FIG. 12 illustrates exemplary states of preparation, selection and evolution pulses when the selection pulse of the Head type is used. The states of the pulses on the first and second lines in FIG. 12 are the same as those on the first and second lines in FIG. 10 and therefore, description of those states will be omitted. The top, second, and third parts of FIG. 12 are the same as the top, second and third parts, respectively, of FIG. 10. This fact shows that in the case of Head type as well, the polarities of the preparation pulse, the selection pulse and the evolution pulse change in the same way as in the case of the Center type and that the voltages of the preparation pulse, the selection pulse and the evolution pulse for causing the cholesteric liquid crystal to display white or black change in the same way as in the case of the Center type.

The fourth part from the top of FIG. 12 illustrates the voltages of the preparation pulse, the selection pulse and evolution pulse for causing the cholesteric liquid crystal to display a whitish gray.

In the first half of the first line, the preparation pulse is at 42 V during the first 2 clock cycles and at 30 V during the next 4 clock cycles. The selection pulse is at 12 V during the first 2 clock cycles and at 0 V during the next 4 clock cycles. The evolution pulse is at 30 V during the first 2 clock cycles and at 18 V during the next 4 clock cycles. In the second half of the first line, the preparation pulse is at 30 V during the first 2 clock cycles and at 42 V during the next 4 clock cycles. The selection pulse is at −12 V during the first 2 clock cycles and at 0 V during the next 4 clock cycles. The evolution pulse is at 18 V during the first 2 clock cycles and at 30 V during the next 4 clock cycles. In the first half of the second line, the preparation pulse is at −42 V during the first 2 clock cycles and at −30 V during the next 4 clock cycles. The selection pulse is at −12 V during the first 2 clock cycles and at 0 V during the next 4 clock cycles. The evolution pulse is at −30 V during the first 2 clock cycles and at −18 V during the next 4 clock cycles. In the second half of the second line, the preparation pulse is at −30 V during the first 2 clock cycles and at −42 V during the next 4 clock cycles. The selection pulse is at 12 V during the first 2 clock cycles and at 0 V during the next 4 clock cycles. The evolution pulse is at −18 V during the first 2 clock cycles and at −30 V during the next 4 clock cycles.

The fifth part from the top of FIG. 12 illustrates the voltages of the preparation pulse, the selection pulse and the evolution pulse for causing the cholesteric liquid crystal to display a gray intermediate between white and black.

In the first half of the first line, the preparation pulse is at 42 V during the first 3 clock cycles and at 30 V during the next 3 clock cycles. The selection pulse is at 12 V during the first 3 clock cycles and at 0 V during the next 3 clock cycles. The evolution pulse is at 30 V during the first 3 clock cycles and at 18 V during the next 3 clock cycles. In the second half of the first line, the preparation pulse is at 30 V during the first 3 clock cycles and at 42 V during the next 3 clock cycles. The selection pulse is at −12 V during the first 3 clock cycles and at 0 V during the next 3 clock cycles. The evolution pulse is at 18 V during the first 3 clock cycles and at 30 V during the next 3 clock cycles. In the first half of the second line, the preparation pulse is at −42 V during the first 3 clock cycles and at −30 V during the next 3 clock cycles. The selection pulse is at −12 V during the first 3 clock cycles and at 0 V during the next 3 clock cycles. The evolution pulse is at −30 V during the first 3 clock cycles and at −18 V during the next 3 clock cycles. In the second half of the second line, the preparation pulse is at −30 V during the first 3 clock cycles and at −42 V during the next 3 clock cycles. The selection pulse is at 12 V during the first 3 clock cycles and at 0 V during the next 3 clock cycles. The evolution pulse is at −18 V during the first 3 clock cycles and at −30 V during the next 3 clock cycles.

The sixth part from the top of FIG. 12 illustrates the voltages of the preparation pulse, the selection pulse and the evolution pulse for causing the cholesteric liquid crystal to display a blackish gray.

In the first half of the first line, the preparation pulse is at 42 V during the first 4 clock cycles and at 30 V during the next 2 clock cycles. The selection pulse is at 12 V during the first 4 clock cycles and at 0 V during the next 2 clock cycles. The evolution pulse is at 30 V during the first 4 clock cycles and at 18 V during the next 2 clock cycles. In the second half of the first line, the preparation pulse is at 30 V during the first 4 clock cycles and at 42 V during the next 2 clock cycles. The selection pulse is at −12 V during the first 4 clock cycles and at 0 V during the next 2 clock cycles. The evolution pulse is at 18 V during the first 4 clock cycles and at 30 V during the next 2 clock cycles. In the first half of the second line, the preparation pulse is at −42 V during the first 4 clock cycles and at −30 V during the next 2 clock cycles. The selection pulse is at −12 V during the first 4 clock cycles and at 0 V during the next 2 clock cycles. The evolution pulse is at −30 V during the first 4 clock cycles and at −18 V during the next 2 clock cycles. In the second half of the second line, the preparation pulse is at −30 V during the first 4 clock cycles and at −42 V during the next 2 clock cycles. The selection pulse is at 12 V during the first 4 clock cycles and at 0 V during the next 2 clock cycles. The evolution pulse is at −18 V during the first 4 clock cycles and −30 V during the next 2 clock cycles.

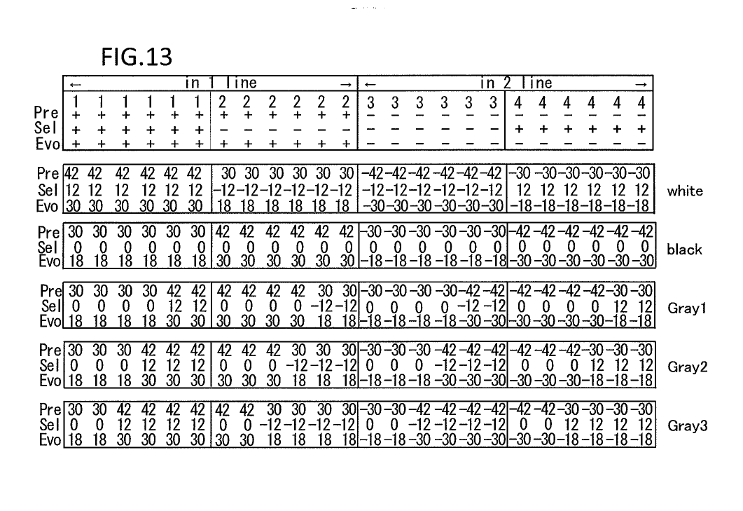

FIG. 13 illustrates exemplary states of preparation, selection and evolution pulses when the selection pulse of the Tail type is used. The states of the pulses on the first and second lines in FIG. 13 are the same as those on the first and second lines in FIG. 10 and therefore, description of those states will be omitted. The top, second, and third parts of FIG. 13 are the same as the top, second and third parts, respectively, of FIG. 10. This fact shows that in the case of Tail type as well, the polarities of the preparation pulse, the selection pulse and the evolution pulse change in the same way as in the case of the Center type and that the voltages of the preparation pulse, the selection pulse and the evolution pulse for causing the cholesteric liquid crystal to display white or black change in the same way as in the case of the Center type.

The fourth part from the top of FIG. 13 illustrates the voltages of the preparation pulse, the selection pulse and evolution pulse for causing the cholesteric liquid crystal to display a whitish gray.

In the first half of the first line, the preparation pulse is at 30 V during the first 4 clock cycles and at 42 V during the next 2 clock cycles. The selection pulse is at 0 V during the first 4 clock cycles and at 12 V during the next 2 clock cycles. The evolution pulse is at 18 V during the first 4 clock cycles and at 30 V during the next 2 clock cycles. In the second half of the first line, the preparation pulse is at 42 V during the first 4 clock cycles and at 30 V during the next 2 clock cycles. The selection pulse is at 0 V during the first 4 clock cycles and −12 V during the next 2 clock cycles. The evolution pulse is 30 V during the first 4 clock cycles and at 18 V during the next 2 clock cycles. In the first half of the second line, the preparation pulse is at −30 V during the first 4 clock cycles and at −42 V during the next 2 clock cycles. The selection pulse is at 0 V during the first 4 clock cycles and at −12 V during the next 2 clock cycles. The evolution pulse is at −18 V during the first 4 clock cycles and at −30 V during the next 2 clock cycles. In the second half of the second line, the preparation pulse is at −42 V during the first 4 clock cycles and at −30 V during the next 2 clock cycles. The selection pulse is at 0 V during the first 4 clock cycles and at 12 V during the next 2 clock cycles. The evolution pulse is at −30 V during the first 4 clock cycles and at −18 V during the next 2 clock cycles.

The fifth part from the top of FIG. 13 illustrates the voltages of the preparation pulse, the selection pulse and the evolution pulse for causing the cholesteric liquid crystal to display a gray intermediate between white and black.

In the first half of the first line, the preparation pulse is at 30 V during the first 3 clock cycles and at 42 V during the next 3 clock cycles. The selection pulse is at 0 V during the first 3 clock cycles and at 12 V during the next 3 clock cycles. The evolution pulse is at 18 V during the first 3 clock cycles and at 30 V during the next 3 clock cycles. In the second half of the first line, the preparation pulse is at 42 V during the first 3 clock cycles and at 30 V during the next 3 clock cycles. The selection pulse is at 0 V during the first 3 clock cycles and at −12 V during the next 3 clock cycles. The evolution pulse is at 30 V during the first 3 clock cycles and at 18 V during the next 3 clock cycles. In the first half of the second line, the preparation pulse is at −30 V during the first 3 clock cycles and at −42 V during the next 3 clock cycles. The selection pulse is at 0 V during the first 3 clock cycles and at −12 V during the next 3 clock cycles. The evolution pulse is at −18 V during the first 3 clock cycles and at −30 V during the next 3 clock cycles. In the second half of the second line, the preparation pulse is at −42 V during the first 3 clock cycles and at −30 V during the next 3 clock cycles. The selection pulse is at 0 V during the first 3 clock cycles and at 12 V during the next 3 clock cycles. The evolution pulse is at −30 V during the first 3 clock cycles and −18 V during the next 3 clock cycles.

The sixth part from the top of FIG. 13 illustrates the voltages of the preparation pulse, the selection pulse and the evolution pulse for causing the cholesteric liquid crystal to display a blackish gray.

In the first half of the first line, the preparation pulse is at 30 V during the first 2 clock cycles and at 42 V during the next 4 clock cycles. The selection pulse is at 0 V during the first 2 clock cycles and at 12 V during the next 4 clock cycles. The evolution pulse is at 18 V during the first 2 clock cycles and at 30 V during the next 4 clock cycles. In the second half of the first line, the preparation pulse is at 42 V during the first 2 clock cycles and at 30 V during the next 4 clock cycles. The selection pulse is at 0 V during the first 2 clock cycles and at −12 V during the next 4 clock cycles. The evolution pulse is at 30 V during the first 2 clock cycles and at 18 V during the next 4 clock cycles. In the first half of the second line, the preparation pulse is at −30 V during the first 2 clock cycles and at −42 V during the next 4 clock cycles. The selection pulse is at 0 V during the first 2 clock cycles and at −12 V during the next 4 clock cycles. The evolution pulse is at −18 V during the first 2 clock cycles and at −30 V during the next 4 clock cycles. In the second half of the second line, the preparation pulse is at −42 V during the first 2 clock cycles and at −30 V during the next 4 clock cycles. The selection pulse is at 0 V during the first 2 clock cycles and at 12 V during the next 4 clock cycles. The evolution pulse is at −30 V during the first 2 clock cycles and at −18 V during the next 4 clock cycles.

FIG. 14 is a graph of the pulse duty and brightness of selection pulses of Center type, Far type, Head type and Tail type.

The horizontal axis of the graph of FIG. 14 represents the pulse duty (%) and the vertical axis represents the normalized brightness of a cholesteric liquid crystal. The black diamonds represent the values of the selection pulse of the Center type, the white rectangles represent the values of the selection pulse of the Far type, the black triangles represent the values of the selection pulse of the Head type, and the christcrosses represent the values of the selection pulse of the Tail type.

At a pulse duty of 0%, the selection pulses of all types provide a brightness level of 0. At a pulse duty of 0.2%, the selection pulses of all types provide brightness levels in the range of 0 to 0.05.

At a pulse duty of 0.3%, the selection pulses of the Center type, the Far type, the Head type, and the Tail type provide brightness levels of approximately 0.13, approximately 0.03, approximately 0.04, and approximately 0.1, respectively.

At a pulse duty of 0.4%, the selection pulses of the Center type, the Far type, the Head type, and the Tail type provide brightness levels of approximately 0.47, approximately 0.05, approximately 0.19 and approximately 0.3, respectively.

At a pulse duty of 0.5%, the selection pulses of the Center type, the Far type, the Head type, and the Tail type provide brightness levels of approximately 0.82, approximately 0.12, approximately 0.50 and approximately 0.64, respectively.

At a pulse duty of 0.6%, the selection pulses of the Center type, the Far type, the Head type and the Tail type provide brightness levels of approximately 0.96, approximately 0.36, approximately 0.81 and approximately 0.90, respectively.

At a pulse duty of 0.7%, the selection pulses of the Center type, the Far type, the Head type and the Tail type provide brightness levels of approximately 0.97, approximately 0.7, approximately 0.96 and approximately 0.96.

At pulse duties of 0.8 and greater, the selection pulses of any of the Center type, the Far type, the Head type and the Tail type provide brightness levels of greater than or equal to 0.96.

Here, the closer to 1 the brightness level is, the closer to white; the closer to 0 the bright level is, the closer to black.

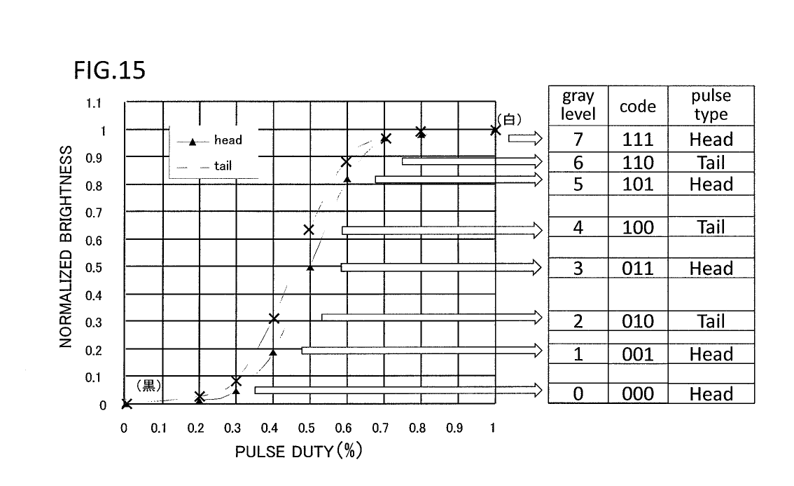

FIG. 15 illustrates an example in which pulse-width-modulated selection pulses of different types were used to produce 8 levels of gray.

Illustrated in FIG. 15 are a graph of brightness versus pulse duty and a code table listing the gray levels of an image that correspond to brightness levels, and codes representing the gray levels.

The vertical axis of the graph of brightness versus pulse duty represents normalized brightness and the horizontal axis represents pulse duty. The black triangles in the graph represent values of pulse-width modulated selection pulses of the Head type and the christcrosses represent values of pulse-width modulated selection pulses of the Tail type.

Referring to the graph and the code table, the following allocation is made to the gray levels of the cholesteric liquid crystal.

Brightness levels in the range of 0 to 0.1 and a selection pulse with a pulse duty of 0 correspond to gray level 0 (code 000). Because the pulse duty is 0, the selection pulse may be of any PWM type.

A brightness level of approximately 0.2 and a Head-type selection pulse with a pulse duty of 0.4 correspond to gray level 1 (code 001).

A brightness level of approximately 0.3 and a Tail-type selection pulse with a pulse duty of 0.4 correspond to gray level 2 (code 010).

A brightness level of approximately 0.5 and a Head-type selection pulse with a pulse duty of 0.5 correspond to gray level 3 (code 011).

A brightness level of approximately 0.65 and a Tail-type selection pulse with a pulse duty of 0.5 correspond to gray level 4 (code 100).

A brightness level of approximately 0.8 and a Head-type selection pulse with a pulse duty of 0.6 correspond to gray level 5 (code 101).

A brightness level of approximately 0.9 and a Tail-type selection pulse with a pulse duty of 0.6 correspond to gray level 6 (code 110).

A brightness level of approximately 0.97 and a selection pulse with a pulse duty 1.0 correspond to gray level 7 (code 111). Because the pulse duty is 1.0, the selection pulse may be of any PWM type.

The 8 levels of gray have been produced by combining Head-type selection pulses and Tail type selection pulses. However, 8 levels of gray may be produced by combining selection pulses of any of the types, including selection pulses of Center type and Far type.

The code table in FIG. 15 is stored in the control circuit 37 of the display apparatus 30 illustrated in FIG. 1. When image data is input in the control circuit 37, the control circuit 37 reads gray-level data from the image data and outputs a code signal corresponding to the gray level. The segment driver 39 receives the code signal and applies a selection pulse of the pulse type and the pulse duty that correspond to the code signal to a given line of the cholesteric liquid crystal.

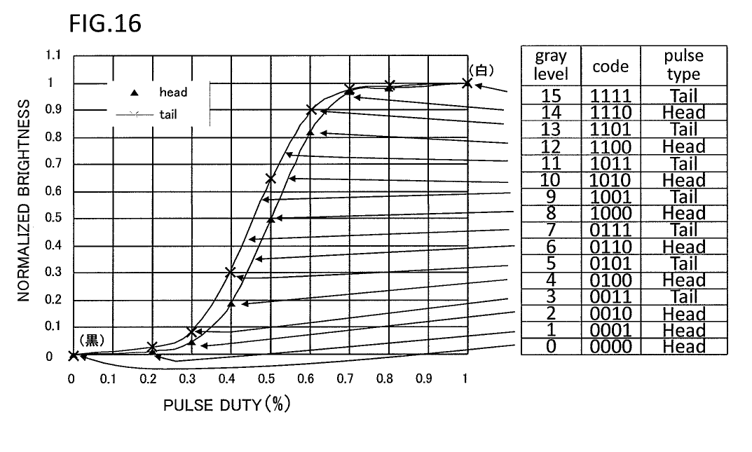

FIG. 16 illustrates an example in which pulse-width-modulated selection pulses of different types were used to produce 16 levels of gray.

Illustrated in FIG. 16 are a graph of brightness versus pulse duty and a code table listing gray levels of an image that correspond to brightness levels, and codes representing the gray levels.

The vertical axis of the graph of brightness versus pulse duty represents normalized brightness and the horizontal axis represents pulse duty. The black triangles in the graph represent values of pulse-width modulated selection pulses of the Head type and the christcrosses represent values of selection pulses of the Tail type.

Referring to the graph and the code table, the following allocation is made to the gray levels of the cholesteric liquid crystal.

A brightness level of 0 and a selection pulse with a pulse duty of 0 correspond to gray level 0 (code 0000). Because the pulse duty is 0, the selection pulse may be of any PWM type.

A brightness level of approximately 0.02 and a selection pulse of the Head type with a pulse duty of 0.2 correspond to gray level 1 (code 0001).

A brightness level of approximately 0.05 and a selection pulse of the Head type with a pulse duty of 0.3 correspond to gray level 2 (code 0010).

A brightness level of approximately 0.09 and a selection pulse of the Tail type with a pulse duty of 0.3 correspond to gray level 3 (code 0011).

A brightness level of approximately 0.2 and a selection pulse of the Head type with a pulse duty of 0.4 correspond to gray level 4 (code 0100).

A brightness level of approximately 0.3 and a selection pulse of the Tail type with a pulse duty of 0.4 correspond to gray level 5 (code 0101).

A brightness level of approximately 0.35 and a selection pulse of the Head type with a pulse duty of 0.45 correspond to gray level 6 (code 0110).

A brightness level of approximately 0.42 and a selection pulse of the Tail type with a pulse duty of 0.45 correspond to gray level 7 (code 0111).

A brightness level of approximately 0.5 and a selection pulse of the Head type with a pulse duty of 0.5 correspond to gray level 8 (code 1000).

A brightness level of approximately 0.58 and a selection pulse of the Tail type with a pulse duty of 0.5 correspond to gray level 9 (code 1001).

A brightness level of approximately 0.65 and a selection pulse of the Head type with a pulse duty of 0.5 correspond to gray level 10 (code 1010).

A brightness level of approximately 0.75 and a selection pulse of the Tail type with a pulse duty of 0.55 correspond to gray level 11 (code 1011).

A brightness level of approximately 0.8 and a selection pulse of the Head type with a pulse duty of 0.6 correspond to gray level 12 (code 1100).

A brightness level of approximately 0.9 and a selection pulse of the Tail type with a pulse duty of 0.6 correspond to gray level 13 (code 1101).

A brightness level of approximately 0.95 and a selection pulse of the Head type with a pulse duty of 0.7 correspond to gray level 14 (code 1110).

A brightness level of approximately 1.0 and a selection pulse with a pulse duty of 1.0 correspond to gray level 15 (code 1111). Because the pulse duty is 1.0, the selection pulse may be of any PWM type.

The 16 levels of gray have been produced by combining Head-type selection pulses and Tail type selection pulses. However, 16 levels of gray may be produced by combining selection pulses of any of the types, including selection pulses of Center type and Far type.

The code table in FIG. 16 is stored in the control circuit 37 of the display apparatus 30 illustrated in FIG. 1. When image data is input in the control circuit 37, the control circuit 37 reads gray-level data from the image data and outputs a code signal corresponding to the gray level. The segment driver 39 receives the code signal and applies a selection pulse of the pulse type and the pulse duty that correspond to the code signal to a given line of the cholesteric liquid crystal.

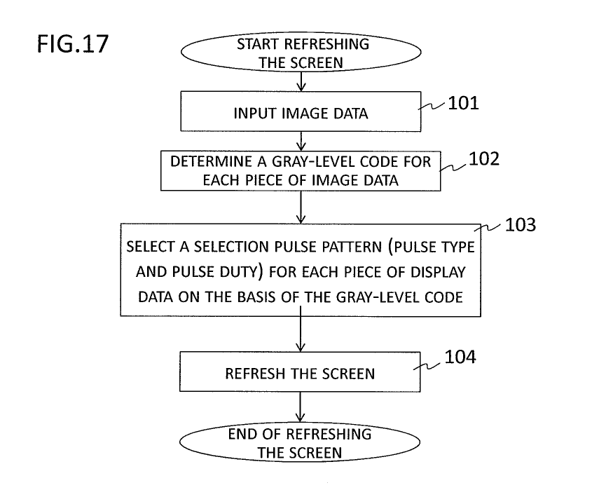

FIG. 17 is a flowchart illustrating a method for refreshing the screen performed in the display apparatus 30 in FIG. 1.

When a refresh instruction is issued to the display apparatus 30, the display apparatus 30 performs the following steps to refresh the screen.

The step of inputting image data (step 101): The driving circuit 40 in the display apparatus 30 causes the control circuit 37 to receive image data 50.

The step of determining a gray-level code for each piece of image data (step 102): The control circuit 37 reads gray level data from the read image data and determines a gray-level code for each piece of image data according to the code table indicating gray levels illustrated in FIG. 15 or 16. The control circuit 37 sends the display data 48 including the gray-level code to the segment driver 39 in order to display an image on the liquid crystal display device 10 or 20. At the same time, the control circuit 37 sends the line selection data LS 41 to the common driver 38. The control circuit 37 acts as a directing circuit that directs the common driver 38 and the segment driver 39 as to which voltage drivers are to be connected to electrodes in order to produce a preparation pulse, a selection pulse and an evolution pulse. Specifically, the control circuit 37 acts as a directing circuit that selects pulse types, including a +12-V pulse and a −12-V pulse and pulse duties for the two pulses according to the gray level of a pixel of the liquid crystal display device 10 or 20 and indicates the result of the selection to the voltage drivers.

The step of selecting a selection pulse pattern for each piece of display data on the basis of the gray-level code (step 103): When the segment driver 39 receives the gray-level code, the segment driver 39 selects a selection pulse corresponding to the gray-level code and outputs the selected selection pulse. The selected selection pulse may be of the Head type or Tail type if the 8 gray levels illustrated in FIG. 15, for example, are used, and has a predetermined pulse duty.

The step of refreshing the screen (step 104): Based on the selected selection pulse and a pulse voltage associated with the pulse, each of the common driver 38 and the segment driver 39 applies the selected selection pulse to an electrode of the liquid crystal display device 10 or 20. As a result the screen of the liquid crystal display device 10 or 20 is refreshed.

In this way, a set of a preparation pulse, a selection pulse and an evolution pulse is sequentially applied scan-line by scan-line. Accordingly, refresh is accomplished in a selection pulse application time per line. Thus, a refresh rate of 1 ms×768=approximately 0.77 seconds may be achieved even on a high-resolution display device conforming to XGA specifications.

Furthermore, since a gray level for the cholesteric liquid crystal is determined by the pulse duty of a selection pulse, the selection pulse may be produced by using only 21-V and 9-V voltage drivers, for example, of the segment driver 39 without having to add power-supply drivers. Consequently, the cholesteric liquid crystal and the driving circuit 40 that drives the cholesteric liquid crystal consume less power than conventional ones.

If selection pulses of only one type were used, with referring to FIGS. 14, 15 and 16, the pulse duty of the selection pulses would need to be finely adjusted in producing multiple gray levels in the cholesteric liquid crystal. In contrast, selection pulses of different types may produce different gray levels even if the pulses have the same pulse duty. Accordingly, multiple gray levels may be produced in the cholesteric liquid crystal by combining selection pulses of different types without needing fine adjustments of the pulse duty.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a depicting of the superiority and inferiority of the invention. Although the embodiments of the present invention have been described in detail, it should be understood that the various changes, substitutions, and alterations could be made hereto without departing from the spirit and scope of the invention.

What is claimed is:

1. A display apparatus comprising:
a display device comprising a cholesteric liquid crystal layer and electrodes sandwiching the cholesteric liquid crystal layer and applying a voltage to a pixel;
a voltage driver capable of applying a first pulse and a second pulse to the electrodes, the first and second pulses having different polarities; and
a directing circuit directing the voltage driver as to a position to which the first pulse is to be applied and a position to which the second pulse is to be applied in a predetermined period according to a gray level to be produced in the pixel.

2. The display apparatus according to claim 1, wherein the directing circuit selects a pulse duty for the first pulse in the predetermined period and a pulse duty for the second pulse in the predetermined period.

3. The display apparatus according to claim 2, wherein gray levels that may be displayed by the pixel is set by two or more of combinations of a direction of modulation of the pulse width of the first pulse and a direction of modulation of the pulse width of the second pulse and by a pulse duty of the first pulse and a pulse duty of the second pulse.

4. The display apparatus according to claim 3, wherein the combinations of a direction of modulation of the pulse width of the first pulse in the predetermined period and a direction of modulation of the pulse width of the second pulse in the predetermined period includes:
a combination of the first pulse and the second pulse, a direction of modulation of the pulse width of the first pulse being the direction away from a boundary between the first and second pulses and the direction of modulation of the pulse width of the second pulse being a direction away from the boundary;
a combination of the first pulse and the second pulse, the direction of modulation of the pulse width of the first pulse being a direction toward the boundary and the direction of modulation of the pulse width of the second pulse is a direction toward the boundary;
a combination of the first pulse and the second pulse, the direction of modulation of the pulse width of the first pulse being the direction away from the boundary and the direction of modulation of the pulse width of the second pulse being the direction toward the boundary; and
a combination of the first pulse and the second pulse, the direction of modulation of the pulse width of the first pulse being the direction toward the boundary and the direction of modulation of the pulse width of the second pulse being the direction away from the boundary.

5. The display apparatus according to claim 4, wherein the boundary is located at the center of the predetermined period.

6. The display apparatus according to claim 1, wherein, in the display device:
the electrodes include a first strip electrode and a second strip electrode sandwiching the cholesteric liquid crystal layer and crossing each other; and
the first and second pulses having different polarities are applied between the first strip electrode and the second strip electrode in the predetermined period.

7. The display apparatus according to claim 1, wherein the voltage driver applies:
a reset pulse including a pulse voltage before the predetermined period, the pulse voltage transforming the cholesteric liquid crystal layer into a homeotropic state;
the first pulse and the second pulse in the predetermined period, the first and second pulses having a pulse voltage providing control to transform the cholesteric liquid crystal layer into a planar state, a focal conic state, or a state in which the planer and focal conic states coexist; and
a maintaining pulse after the predetermined period, the maintaining pulse including a pulse voltage for establishing the planer state, the focal conic state, or the state in which the planer and focal conic states coexist.

8. The display apparatus according to claim 2, wherein,
the display device comprises:
a blue display element displaying a blue color,
a green display element displaying a green color, and
a red display element displaying a red color;
the voltage driver comprises:
a blue color voltage driver capable of applying a combination of blue color pulses including a first blue color pulse and a second blue color pulse to an electrode connecting to a blue pixel of the blue display element, the first and second blue color pluses having different polarities,
a green color voltage driver capable of applying a combination of green color pulses including a first green color pulse and a second green color pulse to an electrode connecting to a green pixel of the green display element, the first and second green color pulses having different polarities, and
a red color voltage driver capable of applying a combination of red color pulses including a first red color pulse and a second red color pulse to an electrode connecting to a red pixel of the red display element, the first and second red color pulses having different polarities; and
the directing circuit comprises:
a blue color directing circuit selecting a center position for the first blue color pulse and a center position for the second blue color pulse in a predetermined period, a pulse duty for the first blue color pulse, and a pulse duty for the second blue color pulse according to a gray level to be produced in the blue pixel, and indicating the result of the selection to the voltage driver;
a green color directing circuit selecting a center position for the first green color pulse and a center position for the second green color pulse in a predetermined period, a pulse duty for the first green color pulse, and a pulse duty for the second green color pulse according to a gray level to be produced in the green pixel, and indicating the result of the selection to the voltage driver; and
a red color directing circuit selecting a center position for the first red color pulse and a center position for the second red color pulse in a predetermined period, a pulse duty for the first red color pulse, and a pulse duty for the second red color pulse according to a gray level to be produced in the red pixel, and indicating the result of the selection to the voltage driver.

9. The display apparatus according to claim 8, wherein when an identical gray level is produced in the blue pixel, the green pixel and the red pixel:
the pulse duty of the first blue color pulse and the pulse duty of the second blue color pulse are greater than the pulse duty of the first green color pulse and the pulse duty of the second green color pulse; and
the pulse duty of the first green color pulse and the pulse duty of the second green color pulse are greater than the pulse duty of the first red color pulse and the pulse duty of the second red color pulse.

10. A method for driving a display apparatus, comprising:
selecting, by a directing circuit, a position to which a first pulse is to be applied and a position to which a second pulse is to be applied in a predetermined period according to a gray level to be produced in a pixel included in a cholesteric liquid crystal layer of a display device of the display apparatus, the first and second pulses having different polarities; and
applying, by a voltage driver, the first and second pulses to the positions of the pixel selected in the selecting step in the predetermined period.

11. The driving method according to claim 10, wherein, in the selecting, a pulse duty for the first pulse in the predetermined period and a pulse duty for the second pulse in the predetermined period are selected.

12. The driving method according to claim 11, wherein gray levels that may be displayed by the pixel is set by two or more of combinations of a direction of modulation of the pulse width of the first pulse and a direction of modulation of the pulse width of the second pulse and by a pulse duty of the first pulse and a pulse duty of the second pulse.

13. The driving method according to claim 12, wherein the combinations of a direction of modulation of the pulse width of the first pulse in the predetermined period and a direction of modulation of the pulse width of the second pulse in the predetermined period includes:
a combination of the first pulse and the second pulse, a direction of modulation of the pulse width of the first pulse being the direction away from a boundary between the first and second pulses and the direction of modulation of the pulse width of the second pulse being a direction away from the boundary;
a combination of the first pulse and the second pulse, the direction of modulation of the pulse width of the first pulse being a direction toward the boundary and the direction of modulation of the pulse width of the second pulse is a direction toward the boundary;
a combination of the first pulse and the second pulse, the direction of modulation of the pulse width of the first pulse being the direction away from the boundary and the direction of modulation of the pulse width of the second pulse being the direction toward the boundary; and
a combination of the first pulse and the second pulse, the direction of modulation of the pulse width of the first pulse being the direction toward the boundary and the direction of modulation of the pulse width of the second pulse being the direction away from the boundary.

14. The driving method according to claim 13, wherein the boundary is located at the center of the predetermined period.

15. The driving method according to claim 10, wherein, in the display device:
the electrodes include a first strip electrode and a second strip electrode sandwiching the cholesteric liquid crystal layer and crossing each other; and
the first and second pulses having different polarities are applied between the first strip electrode and the second strip electrode in the predetermined period.

16. The driving method according to claim 10, wherein the voltage applying step applies:
a reset pulse including a pulse voltage before the predetermined period, the pulse voltage transforming the cholesteric liquid crystal layer into a homeotropic state;
the first pulse and the second in the predetermined period, the first and second pulses having a pulse voltage providing control to transform the cholesteric liquid crystal layer into a planar state, a focal conic state, or a state in which the planer and focal conic states coexist; and
a maintaining pulse after the predetermined period, the maintaining pulse including a pulse voltage for establishing the planer state, the focal conic state, or the state in which the planer and focal conic states coexist.

17. The driving method according to claim 11, wherein,
the display device comprises:
a blue display element displaying a blue color,
a green display element displaying a green color, and
a red display element displaying a red color;
the voltage driver comprises:
a blue color voltage driver capable of applying a combination of blue color pulses including a first blue color pulse and a second blue color pulse to an electrode connecting to a blue pixel of the blue display element, the first and second blue color pluses having different polarities,
a green color voltage driver capable of applying a combination of green color pulses including a first green color pulse and a second green color pulse to an electrode connecting to a green pixel of the green display element, the first and second green color pulses having different polarities, and
a red color voltage driver capable of applying a combination of red color pulses including a first red color pulse and a second red color pulse to an electrode connecting to a red pixel of the red display element, the first and second red color pulses having different polarities; and
the directing circuit comprises:
a blue color directing circuit selecting a center position for the first blue color pulse and a center position for the second blue color pulse in a predetermined period, a pulse duty for the first blue color pulse, and a pulse duty for the second blue color pulse according to a gray level to be produced in the blue pixel, and indicating the result of the selection to the voltage driver;
a green color directing circuit selecting a center position for the first green color pulse and a center position for the second green color pulse in a predetermined period, a pulse duty for the first green color pulse, and a pulse duty for the second green color pulse according to a gray level to be produced in the green pixel, and indicating the result of the selection to the voltage driver; and
a red color directing circuit selecting a center position for the first red color pulse and a center position for the second red color pulse in a predetermined period, a pulse duty for the first red color pulse, and a pulse duty for the second red color pulse according to a gray level to be produced in the red pixel, and indicating the result of the selection to the voltage driver.
